(19) United States
(12) Patent Application Publication
(10) Pub. No.: US 2023/0097228 A1
(43) Pub. Date: Mar. 30, 2023

(54) CONFIGURABLE VEHICULAR STORAGE BIN AND TRAVEL MAT COMBINATION

(71) Applicant: Huyan Fang, Secaucus, NJ (US)

(72) Inventor: Huyan Fang, Secaucus, NJ (US)

(21) Appl. No.: 17/448,812

(22) Filed: Sep. 24, 2021

(51) Int. Cl. B60N 3/04; B60R 7/02; A45C 7/00

(52) U.S. Cl. CPC B60N 3/048; B60R 7/02; A45C 7/0095; A45C 2007/0013

(57) ABSTRACT

A multi-use apparatus configurable into a plurality of carriable organizers as well as a mat configuration. The multi-use apparatus is also moveable to a storage condition taking on an accordion arrangement. The apparatus has a plurality of planar wall panels and corner panels surrounding a central base, wherein the panels are pivotably joined along shared perimeter edges so that each panel is selectively movable between a flat orientation and an upright orientation so that they can collectively be unfolded and folded with respect to one another. The planar panels have an inside surface and an opposing outside surface, but only the inside surfaces of the corner panels have detachable fasteners with non-slip properties, and the only outside surfaces with detachable fasteners are along two opposing wall panels. Two wall panels provide handles for toting each of the plurality of organizer configurations while they contain cargo.

### BACKGROUND OF THE INVENTION

The present invention relates to vehicle cargo organizers and travel mats and, more particularly, a multi-use configurable vehicular storage bin and travel mat combination.

Many vehicle organizers on the market boast of multifunctional features for storage; however, none of them offer adjustable sizing through various storage configurations, and none provide any other utility except storage.

For instance, current trunk organizers are not adjustable in terms of size, thus limiting their use, especially for households with multiple vehicles, wherein each vehicle can have different trunk sizes. Another problem with current trunk organizers is that they do not allow the item to be removed from the car and carried because they lack adequate handles (which would be convenient for multi-vehicle households who may desire to selectively place the same organizer in different vehicles based on need). Accordingly, multi-vehicle households cannot one storage organizer for multiple vehicles, and so need to pony up money to purchase multiple storage organizers.

Moreover, some of the current vehicular organizers take up the entirety of the vehicular trunk and cannot be configured to take different shapes, configurations and/or footprints to accommodate other objects outside of the organizer. These do not work well because if a user needs to use both the organizer and a separate portion of the trunk space at the same time the user would be out of luck. In some situations, the organizer may take up a significant portion of trunk space, yet not accommodate a large object (because the organizer is partitioned), but the user to cannot add the large object outside of the organizer as there is insufficient trunk spaced available. Furthermore, current organizers do not contemplate being moved between vehicles or between a vehicle and another storage space, and so do not have a way to transfer the entire organizer, with the items still inside, in a handy manner to does not spill or dislodge the retained objects.

As can be seen, there is a need for a multi-use collapsible vehicular trunk storage bin and travel mat.

The present invention functions in several ways through various configurations. First, the present invention can be used as a trunk organizer with a plurality of sizing configurations. The apparatus embodied in the present invention can expand or contract to accommodate different trunk sizes the user may have available. Secondly, the present invention has dual handles on either side, allowing for carrying the organizer with objects therein. Lastly, the present invention can be laid flat as a mat, offering protection in a trunk when moving items in and out, wherein the underside of the present invention offers non-slip properties preventing the mat from sliding around the trunk, offering additional security and safety when transporting items.

The present invention embodies a product that is useful for a wider range of vehicle trunk sizes. It allows transferability between different vehicles of different sizes. Additionally, being collapsible, adaptable, and transferable gives the present invention more uses than just storage. In short, the present invention can be a flat mat, a plurality of differently sized storage containers, and a carrying bin.

### SUMMARY OF THE INVENTION

In one aspect of the present invention, apparatus embodying a plurality of configurable cargo organizers and mat, the apparatus includes: a central base; a plurality of walls each wall having a pivotable connection with the central base, wherein each wall comprises a plurality of wall panels, wherein each wall panel is pivotable connected to an adjacent wall panel thereof; a corner flap interconnecting adjacent walls through a pivotable connection to each wall; each corner flap includes a hinge connection extending obliquely relative to said pivotable connections; and a plurality of detachable fasteners disposed along an inside surface of the corner flap, wherein no detachable fasteners are along an inside surface of the plurality of walls.

In another aspect of the present invention, the apparatus includes wherein each wall panel is movable between a flat orientation and an upright orientation in such a way as to be configurable in a plurality of organizer configurations, wherein, for each corner flap, the plurality of inside detachable fasteners is oriented in a mirror image relative to hinged connection, thereby imparting deployment-supporting forces therebetween during deployment of each of the plurality of organizer configurations, wherein, for each corner flap, each of the plurality of organizer configurations provides a different percentage of the plurality of inside detachable fasteners that are engaged, wherein the apparatus is movable the plurality of organizer configurations and a mat configuration, wherein the plurality of walls and corner flaps are in a flat orientation; and further including a plurality of outside detachable fasteners on an outside surface of two of the plurality of walls through not on the outside surface of the corner flaps, wherein the plurality of outside detachable fasteners connect with at least two of the plurality of inside detachable fasteners in a storage configuration wherein a the plurality of walls and the corner flaps have an accordion arrangements, wherein each corner flap comprises four corner panels, and two of the four corner panels share the hinge connection, and wherein said two corner panels pivot in three different directions; and further including a handle on two opposing walls of the plurality of walls, wherein the plurality of organizer configurations comprises a first organizer configuration and a second organizer configuration, wherein the first organizer configuration has a base comprising the central base and a portion of the wall panels, and wherein the second organizer configuration has a base consisting of the central base.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use.

FIG. 2 is a perspective view of an exemplary embodiment of the present invention, shown in a collapsed storage configuration.

FIG. 3 is a perspective view of an exemplary embodiment of the present invention, shown in a flat condition or mat configuration.

FIG. 4 is a perspective view of an exemplary embodiment of the present invention, shown in a first carriable organizer configuration.

FIG. 5 is a perspective view of an exemplary embodiment of the present invention, shown in a second carriable organizer configuration.

FIG. 6 is a perspective view of an exemplary embodiment of the present invention, showing the expanded flat condition or mat configuration in use.

FIG. 7 is a perspective view of an exemplary embodiment of the present invention, showing the first organizer configuration in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a multi-use apparatus configurable into a plurality of carriable organizers as well as a mat configuration. The multi-use apparatus is also moveable to a storage condition taking on an accordion arrangement. The apparatus has a plurality of planar wall panels and corner panels surrounding a central base, wherein the panels are pivotably joined along shared perimeter edges so that each panel is selectively movable between a flat orientation and an upright orientation so that they can collectively be unfolded and folded with respect to one another. The planar panels have an inside surface and an opposing outside surface, but only the inside surfaces of the corner panels have detachable fasteners with non-slip properties, and the only outside surfaces with detachable fasteners are along two opposing wall panels. Two wall panels provide handles for toting each of the plurality of organizer configurations while they contain cargo.

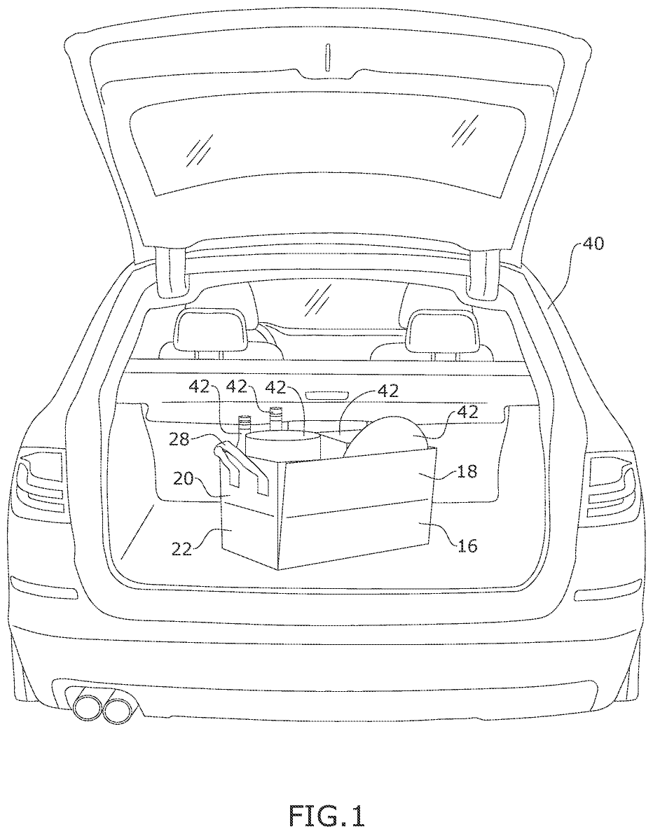

Referring now to FIGS. 1 through 7, the present invention may include a multifunctional apparatus 100 the is configurable among at least a first organizer configuration 110, a second organizer configuration 120, a collapsed storage configuration 130, and a mat configuration, whereby detachable fasteners 30-36 facilities the formation and operability of each of the above listed configurations.

The multifunctional apparatus 100 includes a central base 10 and a plurality of wall panels 12-26 and corner panels 38 pivotable connected to each other, whereby the multifunctional apparatus 100 is movable among the first organizer configuration 110, the second organizer configuration 120, the collapsed storage configuration 130, and the mat configuration through engaging and disengaging various components of the plurality of detachable fasteners 30-36.

The central base 10 may be planar and rectangular with two long perimeter edges and two short perimeter edges. Each wall panel 12-26 may also be generally planar and likewise defined by perimeter edges. Each perimeter edge of the wall panel 12-26 either has a pivotable connection shared with an adjacent perimeter edge (of the central base 10 or an adjacent wall panel) or defines a portion of the periphery 50 of the multifunctional apparatus 100.

The pivotable connections enable each wall panel to be selectively movable between a flat orientation and an upright orientation. Since each wall panel is pivotably connected to a plurality of perimeter edges, each wall panel may pivot selectively about a plurality of axis. Accordingly, the wall panels can collectively be unfolded and folded with respect to one another.

Each wall panel has an outside surface 80 and an inside surface 70 facing opposing directions. By planar, it is understood that in the flat condition, or mat configuration, the entirety of the outside surfaces 80 are coplanar and face in a first direction while the entirety of the inside surfaces 70 are coplanar and face a second directions that faces diametrically opposite the first direction.

Referring to FIG. 3, in one embodiment, the wall panels 12-26 may be generally rectangular and have two pairs of opposing perimeter edges. In certain embodiments, the plurality of wall panel 12-26 may include a first long panel 14 and a second long panel 16 sharing a pivotable connection with opposing edges of the two long edges of the central base 10. A third long panel 12 and a fourth long panel 18 may be disposed to share a pivotable connection with the first long panel 14 and the second long panel 16, respectively, opposite the central base 10.

Similarly, the plurality of wall panel 12-26 may include a first short panel 24 and second short panel 22 sharing a pivotable connection with opposing edges of the two short edges of the central base 10. A third short panel 26 and a fourth short panel 20 may be disposed to share a pivotable connection with the first short panel 24 and the second short panel 22, respectively, opposite the central base 10.

As illustrated in FIG. 3, the central base 10 and the arrangement of the plurality of panels 12-26 define a planar “cross shape”. Each of the four corners of the cross are occupied with a corner flap 38. Each corner flap 38 may include four corner panels 48, each corner panel 48 may have a pivotable connection shared with adjacent perimeter edges of an adjacent corner panels 48 or wall panel 12-26. Two of the four corner panels 48, in a diagonal or oblique position relative to each other, may have a hinged connection 58 extending diagonally or in an oblique direction relative to the inner corner 68 of the above-mentioned “cross shape” to the corner of the periphery 50 of the multifunctional apparatus 100. The hinge connection 58 enables the opposing catty corners of these corner panels 48 to fold, taco-like, between an upright orientation and a flat orientation. Each corner flap 38 may interconnect two wall panels along the periphery 50 of the multifunctional apparatus 100, by way of the pivotable connection (in FIG. 3, long peripheral wall panel 18 is interconnected to short peripheral wall panel 26. One of the corner panels 48 may have rounded peripheral corners.

The corner flap 38 may have a plurality of detachable fasteners disposed on the inside surface 70 thereof. It is important to certain embodiments of the present invention that the inside surface 70 of the central base 10 and plurality of wall panels 12-26 have no (operatively associated) detachable fasteners along their inside surfaces 70 so as not to unintentionally snag or engage with objects 42 that they contain/support or surface of the vehicle 40. Likewise, all but two of the long wall panels on opposing sides of the central base 10, say 18 and 12, have detachable fasteners disposed along their outside surfaces 80, while the remaining wall panels, the central base 10, and the corner flaps 38 do not have detachable fasteners disposed on the outside surface 80 thereof. The lack of detachable fasteners disposed along the outside surface 80 is important for similar reasons as stated above—so they do not interface or unnecessarily engage with supported/contained objects 42 or surface of the vehicle 40.

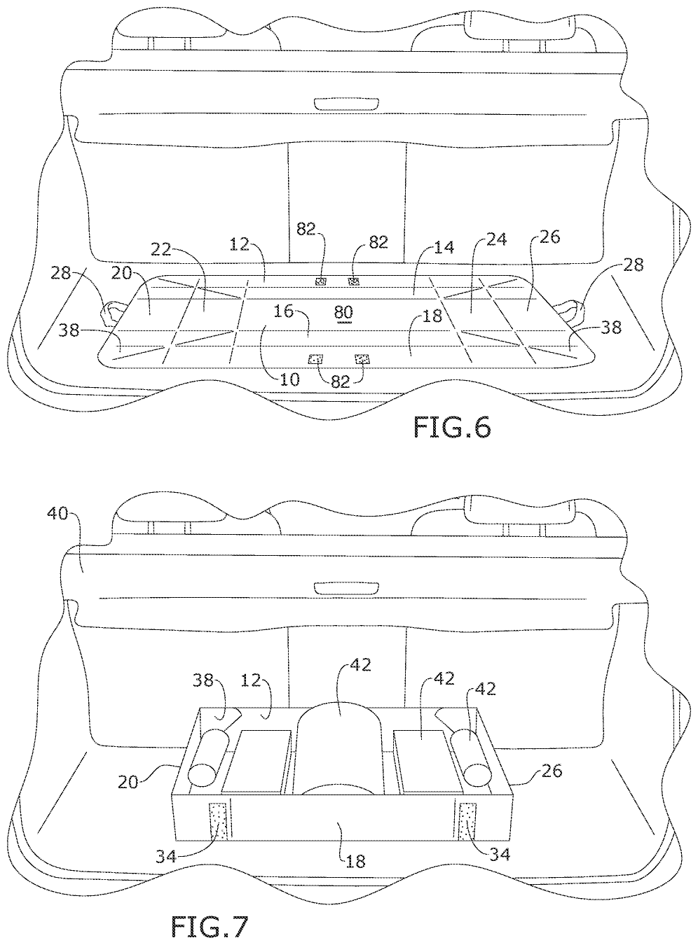

Some of the detachable fasteners may be any detachable fasteners that enable removably connecting one object to another object, such as but not limited to snaps, adhesive, hook and loops, and zippers. Though at least two or more of the detachable fasteners may have non-slip properties (hook and loop, adhesive, or the like) with interfacing supporting surfaces of the vehicle 40 on which the multifunctional apparatus 100 may lay in the mat configuration, as shown in FIG. 6 (with the inside surface 70 facing against said supporting surface, thereby providing a frictional engagement with the vehicle 40 by way of the non-slip properties).

There are two types of complementary detachable fasteners—first detachable fasteners 30/34 and second detachable fasteners 32/36. In the embodiments where the detachable fasteners are hook and loop fasteners, then the first detachable fasteners 30/34 may be loop portions, while the complementary second detachable fasteners 32/36 may be hook portions (or vice versa).

The first and second detachable fasteners 30/34 and 32/36 may be generally disposed as mirror images of each other about the diagonally oriented hinged connection 58, whereby folding the four corner panels 48 about said diagonally oriented hinged connection 58 mates the complementary detachable fasteners, respectively (30 with 32, and separately 34 with 36). It being understood just 30 and 32 may be mated while 34 and 36 are not, like in the first organizer configuration 110 of FIG. 4; or alternatively both sets of complementary detachable fasteners 30-32 and 34-36 may be mated in the second organizer configuration 120 of FIG. 5. Such mating of complementary detachable fasteners along the corner flap 36 provides the tensile force along the laterally adjacent wall panels, maintaining their upright orientation so that said wall panels can act as walls (of different elevations) in the first and second organizer configurations 110 and 120.

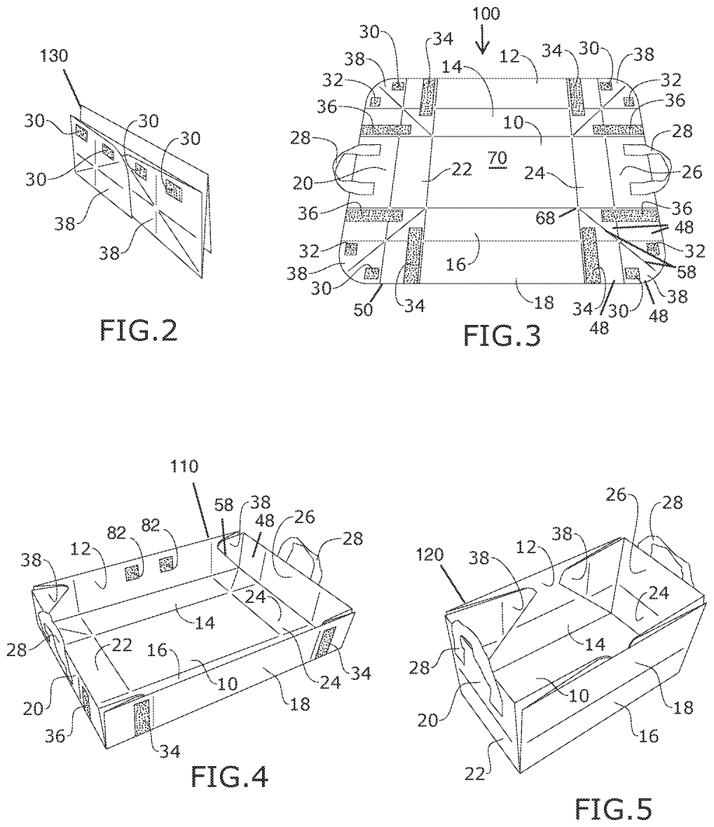

The detachable fasteners 82 along the outside surface 80 may be disposed to mate with the detachable fasteners along the inside surface 70 of the corner flaps 38 in the collapsed storage configuration 130, maintaining the multifunctional apparatus 100 in an accordion arrangement, as illustrated in FIG. 2.

In the mat configuration—i.e., the flat condition where all the panels are in the flat orientation—the non-slip properties of at least some of the plurality of detachable fasteners 30-36 engage the supporting surface of the vehicle 40.

Two opposing wall panels such as 12-18 and/or 20-26 may each provide a handle 28 along their inside surface 70 so that in the first and second organizer configurations 110 and 120 the handles 28 can be manipulated to manually move the organizer configurations 110 and 120 around in or from the vehicle 40.

By raising and lowering its wall panels, the multifunctional apparatus 100 may be selectively deployed between the mat configuration, where each of the wall panels is lowered to their flat orientations, and a plurality of organizer configuration 110 and 120, where at least one set of aligned wall panels adjacent each perimeter edge of the central base 10 are raised to their upright orientations, and the collapsed storage configuration 130, wherein the wall panels are in their flat orientation but in a stacked or parallel orientation relative to other wall panels, wherein some wall panels are overlying or underlying adjacent wall panels. The configurations of deployment are shown in FIGS. 2-5.

In the organizer configurations some or all of the wall panels define a compartment for placing objects 42. The base of the compartment for the second organizer configuration 120 is only the central base 10, while in the first organizer configuration 110, the base of the compartment is the central base 10 and adjacent wall panels 14, 16, 22, 24 and corner panels 48

The sizes of the wall panels 12-26 and corresponding corner panels 48 are dimensioned to cooperate with the central base 10 and the above-mentioned organizer configurations 110 and 120, allowing for various compartment sizes and compartment wall heights, converting a smaller tote to a larger organizer by attaching the wall panels to each other using the detachable fasteners. Then, by opening the detachable fasteners, the organizer flattens and offers a flat mat which can give protection to the vehicle 40 when transporting items.

In a vehicle trunk, the present invention offers organization of various articles 42, whether they are tools or other items. If only a smaller portion of the vehicle is needed to be organized, the organizer can be configured to a more compact size. The present invention can also add extra support to a trunk floor during use and be carried out as a tote for transporting items. When not in use, the present invention neatly folds, and is accessible to the user at any time.

The present invention may be made with sewing machinery, involving fabric and sturdy inserts for the collapsible walls. Various sections may be marked allowing for the organizer to fold at different locations. The dual handles 28 may be reinforced on opposite sides, adding function to the tote feature.

It should be understood, of course, that the foregoing relates to exemplary embodiments of the invention and that modifications may be made without departing from the spirit and scope of the invention as set forth in the following claims.

What is claimed is:

1. An apparatus embodying a plurality of configurable cargo organizers and mat, the apparatus comprising:
a central base;
a plurality of walls each wall having a pivotable connection with the central base, wherein each wall comprises a plurality of wall panels, wherein each wall panel is pivotable connected to an adjacent wall panel thereof;
a corner flap interconnecting adjacent walls through a pivotable connection to each wall;
each corner flap comprises:
a hinge connection extending obliquely relative to said pivotable connections; and
a plurality of detachable fasteners disposed along an inside surface of the corner flap,
wherein no detachable fasteners are along an inside surface of the plurality of walls.

2. The apparatus of claim 1, wherein each wall panel is movable between a flat orientation and an upright orientation in such a way as to be configurable in a plurality of organizer configurations.

3. The apparatus of claim 2, wherein, for each corner flap, the plurality of inside detachable fasteners is oriented in a mirror image relative to hinged connection, thereby imparting deployment-supporting forces therebetween during deployment of each of the plurality of organizer configurations.

4. The apparatus of claim 3, wherein, for each corner flap, each of the plurality of organizer configurations provides a different percentage of the plurality of inside detachable fasteners that are engaged.

5. The apparatus of claim 4, wherein the apparatus is movable the plurality of organizer configurations and a mat configuration, wherein the plurality of walls and corner flaps are in a flat orientation.

6. The apparatus of claim 5, further comprising a plurality of outside detachable fasteners on an outside surface of two of the plurality of walls through not on the outside surface of the corner flaps, wherein the plurality of outside detachable fasteners connect with at least two of the plurality of inside detachable fasteners in a storage configuration wherein a the plurality of walls and the corner flaps have an accordion arrangements.

7. The apparatus of claim 6, wherein each corner flap comprises four corner panels, and two of the four corner panels share the hinge connection, and wherein said two corner panels pivot in three different directions.

8. The apparatus of claim 7, further comprising a handle on two opposing walls of the plurality of walls.

9. The apparatus of claim 8, wherein the plurality of organizer configurations comprises a first organizer configuration and a second organizer configuration, wherein the first organizer configuration has a base comprising the central base and a portion of the wall panels, and wherein the second organizer configuration has a base consisting of the central base.
